(19) United States
(12) Patent Application Publication
(10) Pub. No.: US 2025/0062086 A1
(43) Pub. Date: Feb. 20, 2025

(54) KEYBOARD

(71) Applicant: LITE-ON TECHNOLOGY CORPORATION, Taipei (TW)

(72) Inventors: Cheng-Kun LIAO, Taipei (TW); Ming-Fu Yen, Taipei (TW); Wei-Jung Huang, Taipei (TW); Cheng-Hsiung Huang, Taipei (TW); Chun-Chieh Huang, Taipei (TW)

(21) Appl. No.: 18/804,935

(22) Filed: Aug. 14, 2024

Related U.S. Application Data
(60) Provisional application No. 63/532,437, filed on Aug. 14, 2023.

(30) Foreign Application Priority Data
Jun. 20, 2024 (CN) 202410803641.4

(51) Int. Cl. H01H 13/70; H01H 13/04; H01H 13/10; H01H 13/14

(52) U.S. Cl. CPC H01H 13/70; H01H 13/04; H01H 13/10; H01H 13/14

(57) ABSTRACT

A keyboard including a key module is provided. The key module includes a keycap, a rigid modular circuit board and a linkage element. The linkage element is located between the keycap and the modular circuit board. The key module is detachably disposed on the keyboard, so that the key module, either in its entirety or as a part, could be disassembled from or assembled to the keyboard.

This application claims the benefit of U.S. Provisional Application Ser. No. 63/532,437, filed Aug. 14, 2023, and claims the benefit of China Application Serial No. 202410803641.4, filed Jun. 20, 2024, the subject matter of which is incorporated herein by reference.

### TECHNICAL FIELD

The disclosure relates in general to a keyboard, and more particularly to a keyboard including a key module that can be detachably assembled, either in whole or in part.

### BACKGROUND

A keyboard, typically including numerous keys, serves as an input device that allows the user to input corresponding instructions by pressing these keys. When a keyboard is sold in the market, its color and appearance are pre-determined, and it offers only one type of key pressing experience based on the originally installed keys. If a user desires a different keyboard shape or different key pressing experience, he/she has to purchase another keyboard that meets his/her preferences.

### SUMMARY

The present disclosure relates to a keyboard including a key module that can be individually disassembled and/or assembled, so that the user can replace the key module according to his/her preference.

According to one embodiment of the present disclosure, a keyboard including a key module is provided. The key module includes a keycap, a modular circuit board and a linkage element. The modular circuit board has rigidness. The linkage element is located between the keycap and the modular circuit board. The key module is capable of being individually disassembled from and/or assembled to the keyboard.

According to another embodiment of the present disclosure, a keyboard is provided. The keyboard includes a key module. The key module includes a casing, a number of keycaps, a modular circuit board and a number of linkage elements. The casing has a number of key areas. Each keycap is correspondingly disposed in a corresponding key area. The modular circuit board is disposed on the casing. Each linkage element is located between a corresponding keycap and the modular circuit board.

According to an alternate embodiment of the present disclosure, a keyboard is provided. The keyboard includes a key module and a frame. The key module includes a casing. The frame has a replacement area corresponding to the key module. The key module is disposed in the replacement area of the frame through the casing.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A is a three dimensional diagram of a keyboard viewed from a first angle according to an embodiment of the disclosure.

FIG. 1B is a three dimensional diagram of a keyboard viewed from a second angle of FIG. 1A.

FIG. 2 is an explosion diagram of a key module of the keyboard of FIG. 1A.

FIG. 3 is a top view of a modular circuit board of the key module of FIG. 2.

FIG. 4 is a schematic diagram of assembling the key module of FIG. 2 to a keyboard.

FIG. 5 is a partial enlargement of the keyboard of FIG. 4 after assembling the key module to the keyboard.

FIG. 6 is a schematic diagram of assembling the key module to a keyboard according to another embodiment of the disclosure.

FIG. 7 exemplarily illustrates a cross-sectional view of the keyboard of FIG. 6.

FIG. 8A is a schematic diagram of a key module according to an embodiment of the disclosure.

FIG. 8B is a schematic diagram of a key module according to another embodiment of the disclosure.

FIG. 9A is an explosion diagram of the key module of FIG. 8A.

FIG. 9B is an explosion diagram of the key module of FIG. 8B.

FIG. 10 to FIG. 12 are cross-sectional views exemplarily illustrating a number of examples of keyboards according to another embodiment of the disclosure.

FIG. 13 exemplarily illustrates a cross-sectional view of the keyboard according to another embodiment of the disclosure.

FIG. 14 is a top view of a keyboard according to another embodiment of the disclosure.

FIG. 15 exemplarily illustrates a cross-sectional view of the keyboard of FIG. 14.

FIG. 16 to FIG. 18 are cross-sectional views exemplarily illustrating a number of examples of keyboards according to another embodiment of the disclosure.

### DETAILED DESCRIPTION

Detailed descriptions of each embodiment of the present disclosure are disclosed below with reference to accompanying drawings. Apart from the said detailed descriptions, any embodiments in which the present disclosure can be used as well as any substitutions, modifications or equivalent changes of the said embodiments are within the scope of the present disclosure, which is defined by the claims. Specific details and embodiments are disclosed in the specification for anyone ordinary skilled in the art to comprehensively understand the present disclosure, not for limiting the present disclosure. Moreover, generally known procedures or elements are not disclosed to avoid adding unnecessary restrictions to the present disclosure.

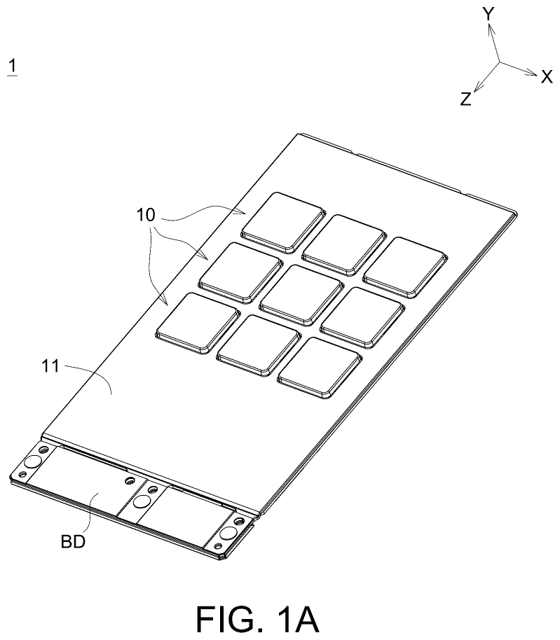

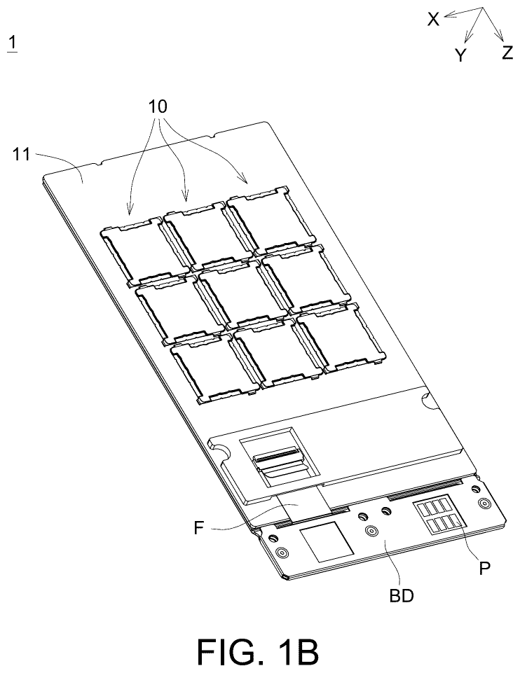

FIG. 1A is a three dimensional diagram of a keyboard viewed from a first angle according to an embodiment of the disclosure. FIG. 1B is a three dimensional diagram of a keyboard viewed from a second angle of FIG. 1A.

Refer to FIG. 1A and FIG. 1B. The keyboard 1 may include a number of key modules 10 and a main circuit board 11. The key modules 10 can be electrically connected to the main circuit board 11. In an embodiment, the keyboard 1 can be an input device of a notebook computer; the main circuit board 11 can be connected to a conversion board BD through a flexible connection wire F, then is further electrically connected to a system circuit board of a notebook computer through an exposed pad P of the conversion board BD.

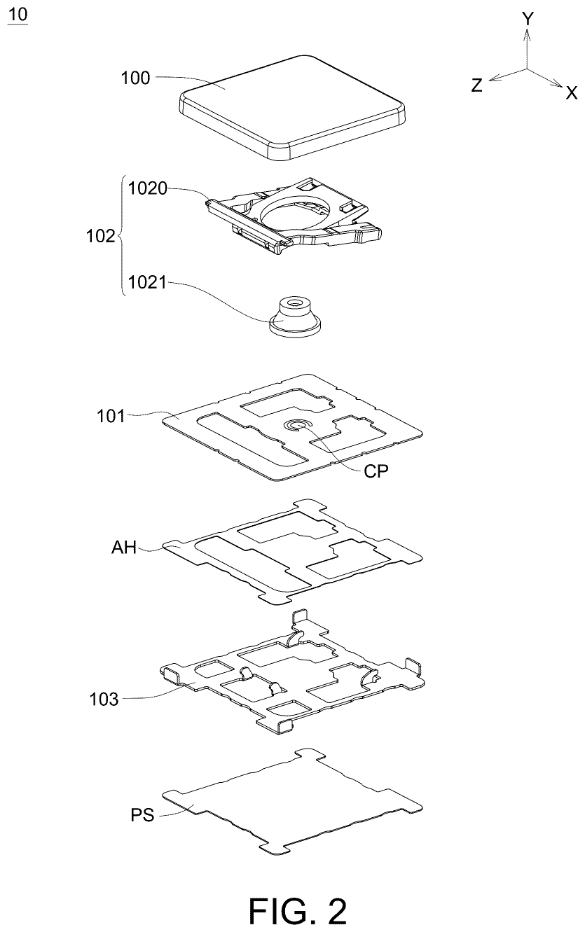

FIG. 2 is an explosion diagram of a key module 10 of the keyboard of FIG. 1A.

Refer to FIG. 2. Each of the key modules 10 may include a keycap 100, a modular circuit board 101, a linkage element 102 and a bottom plate 103. The linkage element 102 is located between the keycap 100 and the modular circuit board 101. The modular circuit board 101 can be located above the bottom plate 103. The modular circuit board 101 and the bottom plate 103 can be fixed with each other through an adhesive layer AH. Besides, the bottommost part of the key module 10 can have a protection sheet PS disposed thereon to protect the internal structure of the key module 10.

When the keycap 100 is pressed, the linkage element 102 can drive the keycap 100 to move along the Y-axis. In an embodiment, the linkage element 102 may include a connection structure 1020 and an elastic member 1021. The connection structure 1020 is disposed between the keycap 100 and the bottom plate 103. The elastic member 1021 is disposed between the keycap 100 and the modular circuit board 101, and the interior of the elastic member 1021 can have a conductive column that can be electrically conducted. The modular circuit board 101 may have a conducting point CP and a circuit; the conducting point CP may correspond to the conductive column inside the elastic member 1021. When the keycap 100 receives a pressing force, the elastic member 1021 will be deformed, so that the conductive column inside the elastic member 1021 can be electrically connected with the conducting point CP of the modular circuit board 101 to generate a triggering signal. Once the pressing force is no longer applied on the keycap 100, the elastic member 1021 can then apply a restoring force to the keycap 100, and the keycap 100 can be moved to the original positon through the guidance of the connection structure 1020.

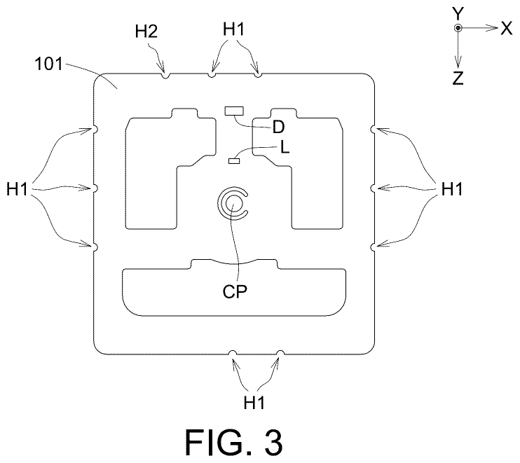

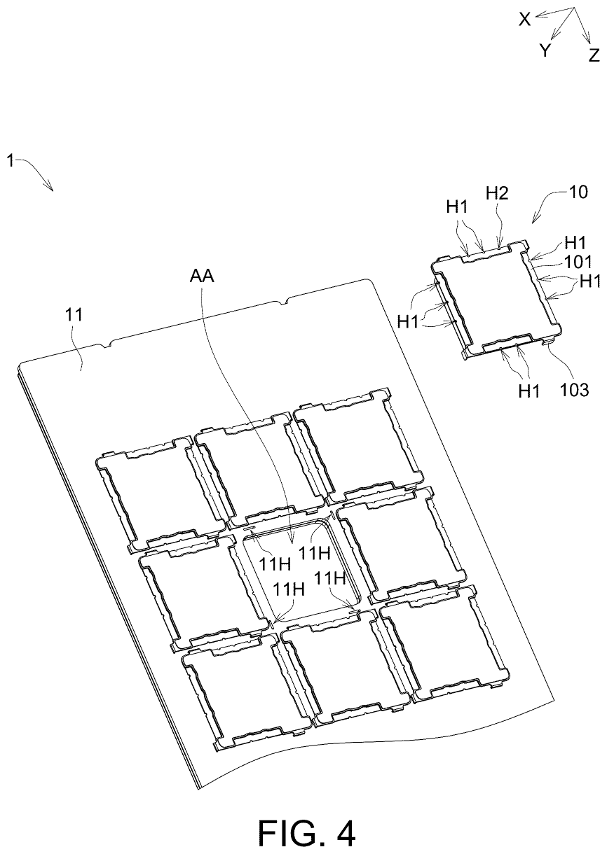

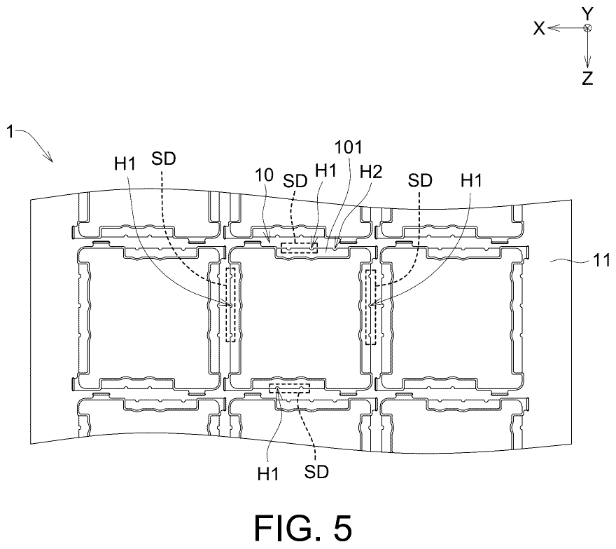

FIG. 3 is a top view of a modular circuit board 101 of the key module 10 of FIG. 2. FIG. 4 is a schematic diagram of assembling the key module 10 of FIG. 2 to the keyboard 1. FIG. 5 is a partial enlargement of the keyboard 1 of FIG. 4 after assembling the key module 10 to the keyboard 1.

Refer to FIG. 3 and FIG. 4. The modular circuit board 101 and the main circuit board 11 both are structures with rigidness. That is, the modular circuit board 101 and the main circuit board 11 can be rigid. For instance, the modular circuit board 101 and the main circuit board 11 can both be implemented by a printed circuit board assembly (PCBA). Thus, the modular circuit board 101 can have other electronic elements such as diodes D or light emitting diodes L disposed thereon.

Refer to FIG. 3 and FIG. 4. The edges of the modular circuit board 101 can have a number of connection holes H1 and at least one alignment hole H2. The shape of the alignment hole H2 can be different from the shape of the connection holes H1, so that the two types of holes can be differentiated. As indicated in FIG. 4, the main circuit board 11 may have an accommodation area AA for receiving the keyboard module 10, and at the vicinity of the accommodation area AA, there are positioning holes 11H for being coupled with the bent hook (not shown) on the bottom plate 103 of the keyboard module 10. Besides, the main circuit board 11 further may have mark symbols (not shown) for alignment purpose. By aligning with the mark symbols on the main circuit board 11, the alignment of the keyboard module 10 can be achieved by the alignment hole H2 on the modular circuit board 101, so that the bottom plate 103 of the keyboard module 10 can be engaged with the main circuit board 11 through the bent hook and the positioning hole 11H, and the keyboard module 10 can be located in the accommodation area AA of the main circuit board 11.

The key module 10 can be electrically connected to the main circuit board 11 through the modular circuit board 101. Refer to FIG. 4 and FIG. 5. When the keyboard module 10 is located in the accommodation area AA of the main circuit board 11, a bonding area SD can be formed between the connection holes H1 of the modular circuit board 101 and the main circuit board 11. Specifically, the main circuit board 11 may have a bare copper whose position is corresponding to each connection hole H1 of the modular circuit board 101, and the connection holes H1 of the modular circuit board 101 may be correspondingly connected to the bare copper on the main circuit board 11 by metal bonding or soldering, so that the modular circuit board 101 can be electrically connected to the main circuit board 11.

The connection holes H1 of the modular circuit board 101 are electrically coupled with the main circuit board 11 by way of bonding or soldering. When one of the key modules 10 fails, the failed key module 10 alone can be detached from the keyboard 1 for repair purpose or can be replaced by another key module 10, not only greatly reducing repair cost but further increasing repair convenience.

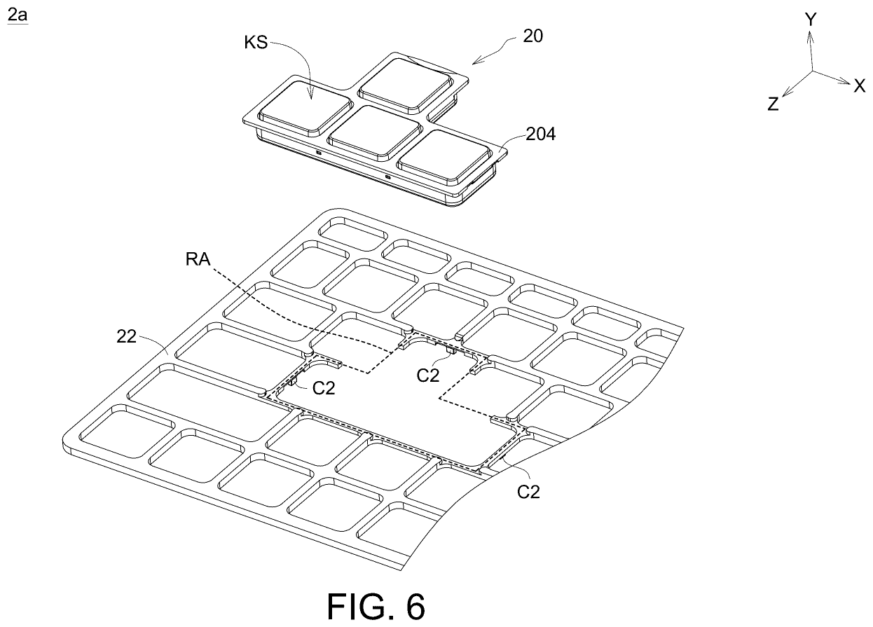

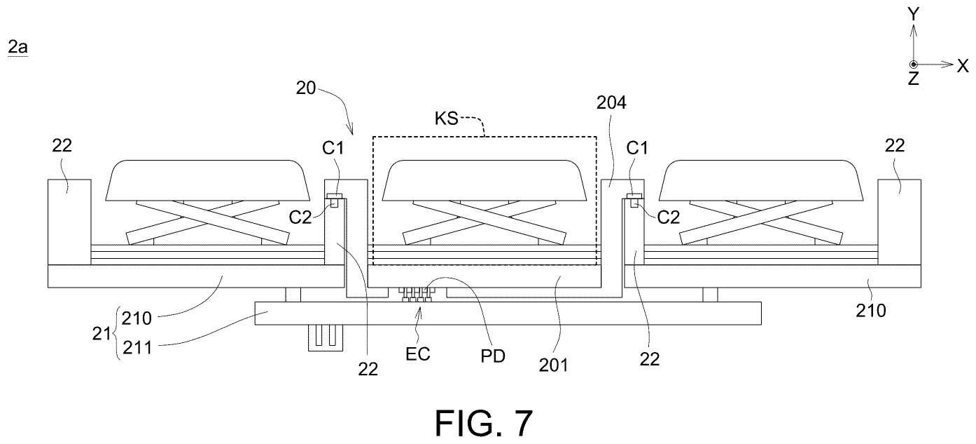

FIG. 6 is a schematic diagram of assembling the key module 20 to a keyboard 2a according to another embodiment of the disclosure. FIG. 7 exemplarily illustrates a cross-sectional view of the keyboard 2a of FIG. 6.

Refer to FIG. 6 and FIG. 7. The keyboard 2a may include a key module 20, a main circuit board 21 (not shown in FIG. 6) and a frame 22. The frame 22 may have a replacement area RA, corresponding to the key module 20, for receiving the key module 20. The key module 20, either in its entirety or as a part, is detachably disposed in the replacement area RA. In an embodiment, the key module 20 can be individually disassembled from or assembled to the replacement area RA on the frame 22 according to the user's needs.

The key module 20 may include a key structure KS and a modular circuit board 201. The modular circuit board 201 and the main circuit board 21 both are structures with rigidness, and both can be implemented by a PCBA, for example. The key structure KS can share the modular circuit board 201 with other key structure. The key module 20 may further include a casing 204, and the key structure KS and the modular circuit board 201 can be disposed on the casing 204, so that the key module 20 can be realized by a modular structure formed in one piece.

The modular circuit board 201 may include a pad PD that can be exposed by the casing 204. The main circuit board 21 may include a first portion 210 and a second portion 211. There is a height difference between the first portion 210 and the second portion 211 on the Y-axis. When the key module 20 is received in the replacement area RA, the height difference corresponds to the thickness of the casing 204 on the bottom of the key module 20. The main circuit board 21 may include an electrical connector EC, such as a pogo pin connector. The electrical connector EC is disposed on the second portion 211 of the main circuit board 21. The modular circuit board 201 and the main circuit board 21 can be electrically connected with each other through the pad PD and the electrical connector EC.

The key module 20 may include a first coupling element C1, which can be disposed on the casing 204. The keyboard 2a may include a second coupling element C2, which can be disposed on the frame 22. The key module 20 can be disassembled from or assembled to the replacement area RA on the frame 22 by using the first coupling element C1 and the second coupling element C2. In an embodiment, the first coupling element C1 and the second coupling element C2 can respectively be a magnetic element and a magnetic attraction component respectively, and the key module 20 can be individually disassembled from or assembled to the frame 22 by way of magnetic attraction.

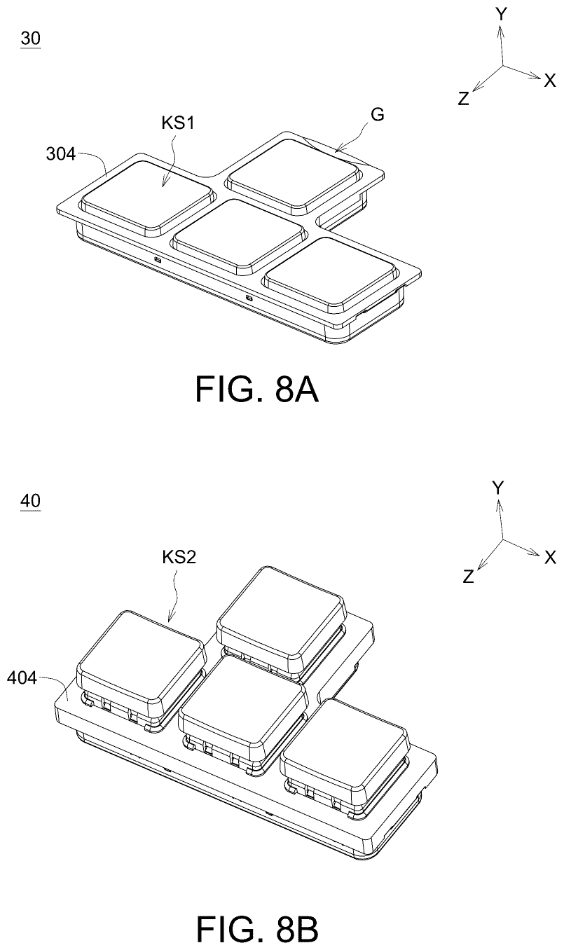

FIG. 8A is a schematic diagram of a key module 30 according to an embodiment of the disclosure. FIG. 8B is a schematic diagram of a key module 40 according to another embodiment of the disclosure.

Refer to FIG. 8A and FIG. 8B. The key module 30 may include a key structure KS1. The key module 40 may include a key structure KS2. The key structure KS1 and the key structure KS2 belong to different types and provide different key pressing experience. The key structure KS of FIG. 7 can be the key structure KS1 of FIG. 8A or the key structure KS2 of FIG. 8B. The differences between the two types of key structure are disclosed below.

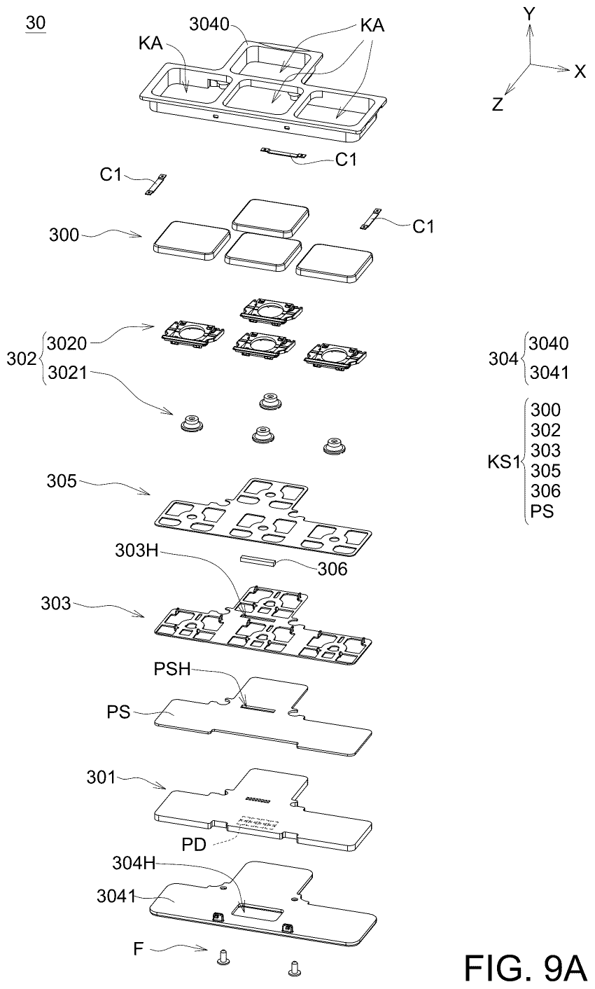

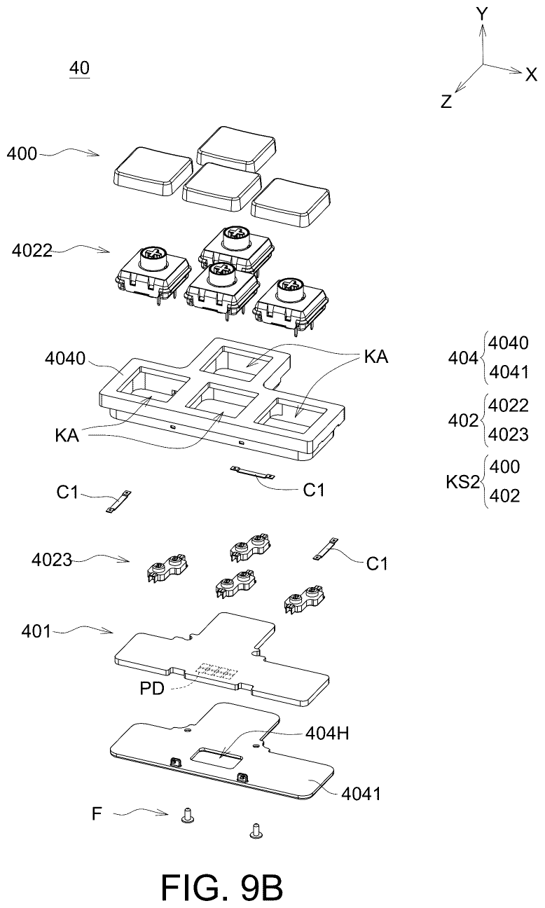

FIG. 9A is an explosion diagram of the key module 30 of FIG. 8A. Refer to FIG. 8A and FIG. 9A. The key module 30 may include a key structure KS1, a modular circuit board 301 and a casing 304. The modular circuit board 301 has structure with rigidness and can be implemented by a PCBA, for example. The key structure KS1 can share the modular circuit board 301 with other key structure. The key structure KS1 is disposed above the modular circuit board 301, and the key structure KS1 and the modular circuit board 301 are disposed on the casing 304.

The casing 304 may include a framework 3040 and a cover 3041. The framework 3040 and the cover 3041 can be coupled with each other, for example, by way of buckling and/or by a fixing element F passing through the cover 3041 from outside the casing 304 to be fixed on the framework 3040. The casing 304 may have a number of key areas KA. The key areas KA can be on the framework 3040.

The key structure KS1 may include a number of keycaps 300, a number of linkage elements 302, a bottom plate 303, a triggering circuit layer 305, an electrical conductive adhesive 306 and a protection sheet PS. Each keycap 300 can be correspondingly disposed in a corresponding key area KA on the casing 304. The triggering circuit layer 305 can be implemented by a thin-film circuit layer, for example, and can be located between the keycap 300 and the modular circuit board 301. The bottom plate 303 can be located between the triggering circuit layer 305 and the modular circuit board 301. Besides, the protection sheet PS can be disposed between the bottom plate 303 and the modular circuit board 301.

Each linkage element 302 respectively is located between a corresponding keycap 300 and a modular circuit board 301. When the keycap 300 is pressed, the linkage element 302 can drive the keycap 300 to move along the Y-axis. In an embodiment, each linkage element 302 may include a connection structure 3020 and an elastic member 3021. The connection structure 3020 is disposed between the keycap 300 and the bottom plate 303. The elastic member 3021 is disposed between the keycap 300 and the triggering circuit layer 305. When the keycap 300 receives a pressing force, the elastic member 3021 will be deformed, so that the elastic member 3021 is pressed and makes the upper layer circuit and the lower layer circuit of the triggering circuit layer 305 be electrically connected to each other to generate a triggering signal. Once the pressing force is no longer applied on the keycap 300, the elastic member 3021 can apply a restoring force to the keycap 300, so that the keycap 300 can return to the original position through the guidance of the connection structure 3020.

The conductive adhesive 306 can be paints or polymers (e.g., synthetic resin or silicone) doped with conductive components. The conductive adhesive 306 is, for example, a conductive rubber, and can be disposed between the triggering circuit layer 305 and the modular circuit board 301 to electrically connect the triggering circuit layer 305 and the modular circuit board 301, so that the triggering signal of the triggering circuit layer 305 can be transmitted to the modular circuit board 301 along the Y-axis direction. The conductive adhesive 306 can pass through the through hole 303H on the bottom plate 303 and the through hole PSH on the protection sheet PS to be connected to the first surface of the modular circuit board 301 facing the positive direction of the Y-axis. Besides, the fixing element F can pass through the cover 3041 from outside the casing 304 to tightly fix the conductive adhesive 306 between the triggering circuit layer 305 and the modular circuit board 301.

The modular circuit board 301 may include a pad PD. The pad PD can be disposed on the second surface of the modular circuit board 301 facing the negative direction of the Y-axis, and the pad PD can be exposed by the casing 304 from the opening 304H disposed on the cover 3041. Thus, by replacing the key module 20 of FIG. 7 with the key module 30 of FIG. 8A and FIG. 9A, the modular circuit board 301 and the main circuit board 21 can be electrically connected with each other through the pad PD and the electrical connector EC.

The way of replacing the key module 20 with the key module 30 is similar to the way of FIG. 7, in which the first coupling element C1 is disposed on the casing 304. Specifically, the first coupling element C1 can be disposed on the edges by which the framework 3040 of the casing 304 is coupled with the frame 22 of the keyboard 2a. Thus, the key module 30 can be disassembled from or assembled to the replacement area RA of the frame 22 through the first coupling element C1 and the second coupling element C2 that is disposed on the frame 22, so that different key pressing experience can be provided.

Besides, the casing 304 can have a grip portion G disposed thereon. The grip portion G can be disposed on the framework 3040 of the casing 304. The user can remove the key module 30 from the frame of the keyboard by flipping the grip portion G with his/her finger directly.

FIG. 9B is an explosion diagram of the key module 40 of FIG. 8B. Refer to FIG. 9B. The key module 40 may include a key structure KS2, a modular circuit board 401 and a casing 404. The modular circuit board 401 has structure with rigidness and can be implemented by a PCBA, for example. The key structure KS2 can share the modular circuit board 401 with other key structure. The key structure KS2 is disposed above the modular circuit board 401, and the key structure KS2 and the modular circuit board 401 are disposed on the casing 404.

The casing 404 may include a framework 4040 and a cover 4041. The framework 4040 and the cover 3041 can be coupled with each other such as by way of buckling and/or by a fixing element F passing through the cover 4041 to be fixed on the framework 4040 from outside the casing 404. The casing 404 may have a number of key areas KA. The key areas KA can be on the framework 4040.

The key structure KS2 may include a number of keycaps 400 and a number of linkage elements 402. Each keycap 400 can be correspondingly disposed in a corresponding key area KA on the casing 404. Each linkage element 402 is located between a corresponding keycap 400 and the modular circuit board 401. When the keycap 400 is pressed, the linkage element 402 can drive the keycap 400 to move along the Y-axis. In an embodiment, each linkage element 402 may include a shaft 4022 and a base 4023. Each base 4023 is disposed on the modular circuit board 401. Each shaft 4022 is located between a corresponding keycap 400 and each base 4023. The shaft 4022 can be a mechanical axis or an optical axis, and the type of the shaft 4022 is not for limiting the invention. When the keycap 400 receives a pressing force, the driving element inside the shaft 4022 can be driven to move and generate a triggering signal. Once the pressing force is no longer applied on the keycap 400, the restoring component inside shaft 4022 can apply a restoring force to the keycap 400 to make the keycap 400 return to the original position.

The modular circuit board 401 may include a pad PD. The pad PD can be disposed on the surface of the modular circuit board 401 facing the negative direction of the Y-axis, and the pad PD can be exposed by the casing 404 from the opening 404H exposed by the cover 4041. Thus, by replacing the key module 20 of FIG. 7 with the key module 40 of FIG. 8B and FIG. 9B, the modular circuit board 401 and the main circuit board 21 can be electrically connected to each other through the pad PD and the electrical connector EC.

The way of replacing the key module 20 with the key module 40 is similar to the way of FIG. 7, in which the first coupling element C1 is disposed on the casing 404. Specifically, the first coupling element C1 can be disposed on the edges by which the framework 4040 of the casing 404 is coupled with the frame 22 of the keyboard 2a. Thus, the key module 40 can be disassembled from or assembled to the replacement area RA of the frame 22 through the first coupling element C1 and the second coupling element C2 that is disposed on the frame 22, so that different key pressing experience can be provided.

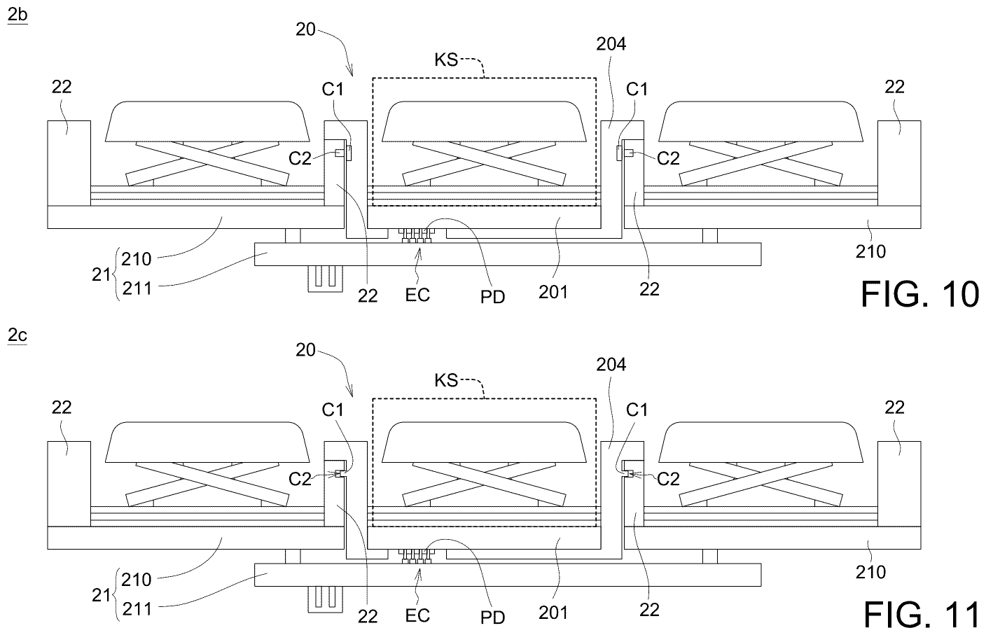

FIG. 10 to FIG. 12 are cross-sectional views exemplarily illustrating a number of examples of keyboards 2b-2d according to another embodiment of the disclosure.

Refer to FIG. 10. The keyboard 2b is basically similar to the keyboard 2a of FIG. 7, and the difference lies in the position at which the first coupling element C1 is disposed on the casing 204 and the position at which the second coupling element C2 is disposed on the frame 22. The key module 20 can be disassembled from or assembled to the replacement area RA on the frame 22 through the first coupling element C1 and the second coupling element C2.

Refer to FIG. 11. The keyboard 2c is basically similar to the keyboard 2b of FIG. 10, and the difference lies in the types of the first coupling element C1 and the second coupling element C2. In FIG. 11, the first coupling element C1 and the second coupling element C2 respectively can be a hook structure and a slot, and the key module 20 can be individually disassembled from or assembled to the frame 22 by de-buckling and buckling the hook structure and the slot.

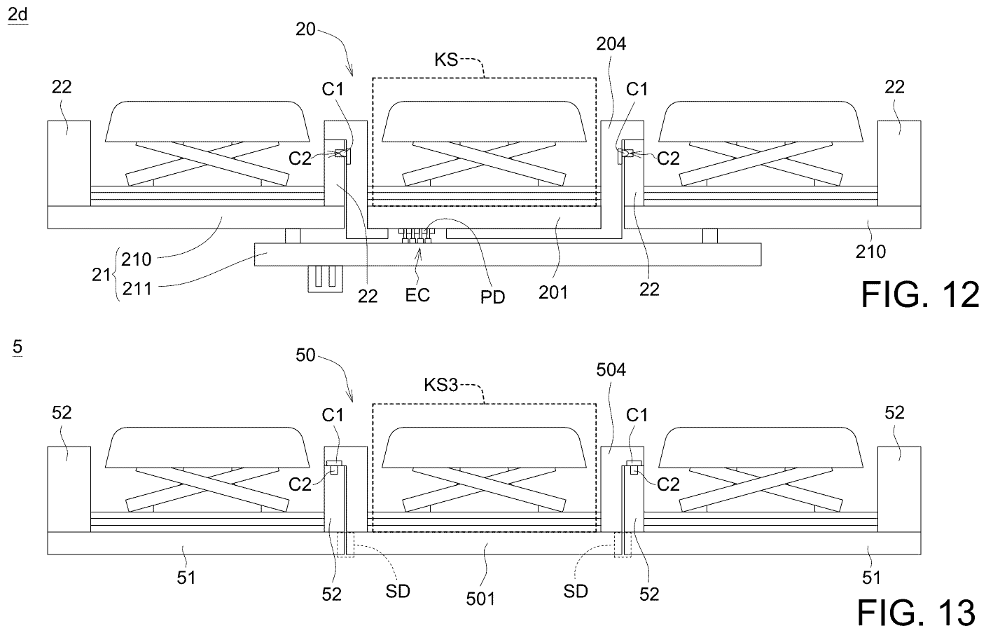

Refer to FIG. 12. The keyboard 2d is basically similar to the keyboard 2b of FIG. 10, and the difference lies in the types of the first coupling element C1 and the second coupling element C2. In FIG. 12, the first coupling element C1 and the second coupling element C2 respectively can be a spring structure and a slot, and the key module 20 can be individually disassembled from or assembled to the frame 22 by de-buckling and buckling the spring structure in the slot.

FIG. 13 exemplarily illustrates a cross-sectional view of the keyboard 5 according to another embodiment of the disclosure. Refer to FIG. 13. The keyboard 5 may include a key module 50, the main circuit board 51 and the frame 52. The frame 52 may have a replacement area (not shown) for receiving the key module 50. The key module 50, either in its entirety or as a part, is detachably engaged with the frame 52. In an embodiment, the key module 50 can be individually disassembled from or assembled to the replacement area of the frame 52 according to the user's needs.

In the embodiment of FIG. 13, the key module 50 may include a key structure KS3, a modular circuit board 501 and a casing 504. The key structure KS3 can be similar to the key structure KS1 FIG. 8A, which is driven by a connection structure, or similar to the key structure KS2 of FIG. 8B, which is driven by a shaft and has only one keycap. The key structure KS3 is disposed above the modular circuit board 501, and the key structure KS3 and the modular circuit board 501 are disposed on the casing 504.

The modular circuit board 501 and the main circuit board 51 both are structures with rigidness, can be implemented by a PCBA, for example. In the present embodiment, the casing 504 is not covered under the modular circuit board 501, therefore the bottom of the key module 50 is the modular circuit board 501. Like the modular circuit board 101 of FIG. 3, the modular circuit board 501 can have a number of connection holes (not shown) disposed thereon. A bonding area SD can be formed between the connection holes of the modular circuit board 501 and the main circuit board 51, and the connection holes can be correspondingly bonded or soldered on the bare copper disposed on the main circuit board 51, so that the modular circuit board 501 can be electrically connected to the main circuit board 51.

The way of replacing the key module 50 can be similar to the way of FIG. 7, in which the first coupling element C1 is disposed on the casing 504 and the second coupling element C2 is disposed on the frame 52, so that the key module 50 can be disassembled from or assembled to the replacement area of the frame 52 through the first coupling element C1 and the second coupling element C2, so that different key pressing experience can be provided by the key structure KS3.

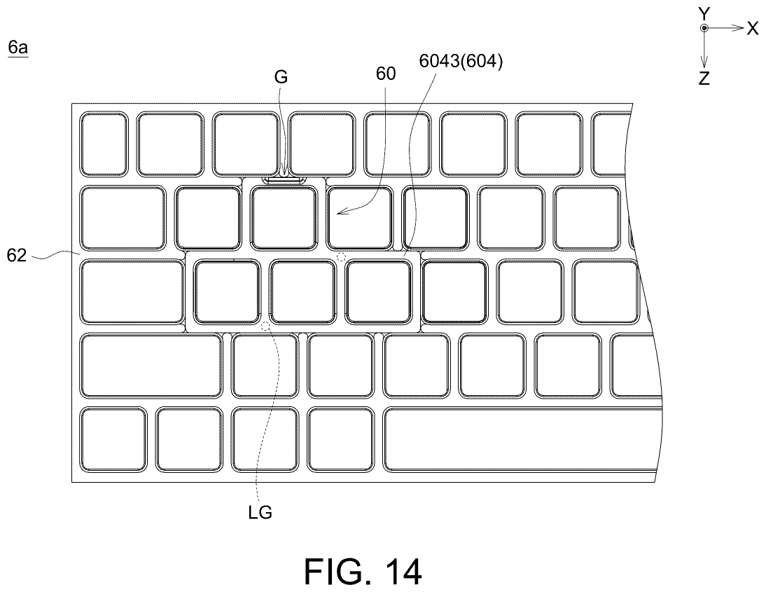

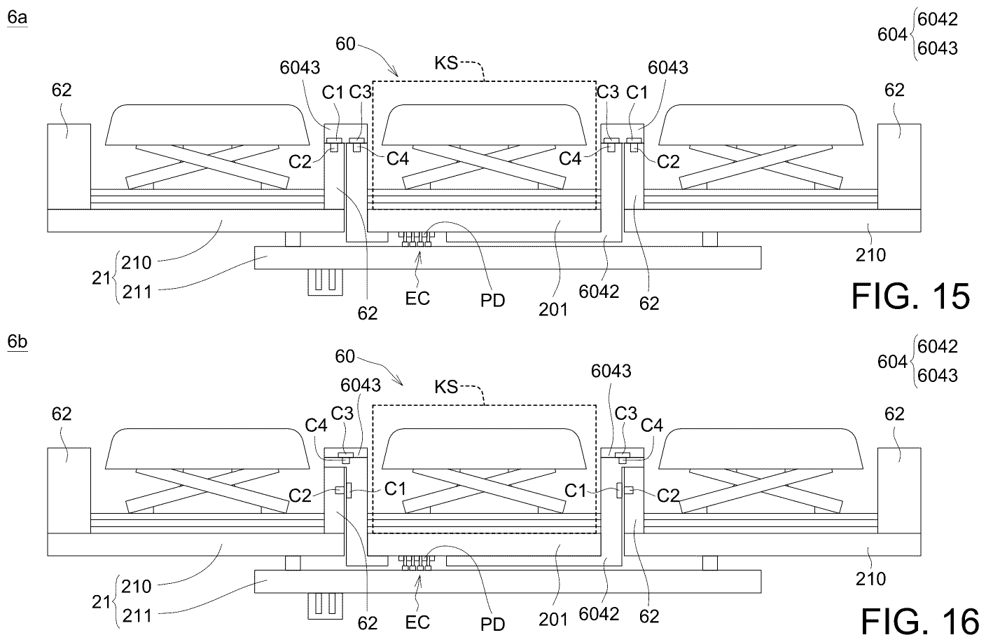

FIG. 14 is a top view of a keyboard 6a according to another embodiment of the disclosure. FIG. 15 exemplarily illustrates a cross-sectional view of the keyboard 6a of FIG. 14.

Refer to FIG. 14 and FIG. 15. The keyboard 6a may include a key module 60, a main circuit board 21 and a frame 62. The frame 62 may have a replacement area (not shown) for receiving the key module 60. The key module 60, either in its entirety or as a part, is detachably engaged with the frame. In an embodiment, the key module 60 can be individually disassembled from or assembled to the replacement area of the frame 62 according to the user's needs.

The key module 60 may include a key structure KS and a modular circuit board 201. The key structure KS can be the key structure KS1 of FIG. 8A or the key structure KS2 of FIG. 8B. The key structure KS can share the modular circuit board 201 with other key structure. The key module 60 further may include a casing 604, and the key structure KS and the modular circuit board 201 can be disposed on the casing 604, so that the key module 60 can be realized by a modular structure formed in one piece.

The embodiments of FIG. 14 and FIG. 15 are basically similar to that of FIG. 6 and FIG. 7, and the difference lies in that the casing 604 includes a body portion 6042 and a decorative portion 6043, wherein the decorative portion 6043 is the part of the casing 604 of the key module 60 when the user views the keyboard 6a from the positive direction of the Y-axis.

The decorative portion 6043 can be disassembled from or assembled to the body portion 6042 according to the user's needs. For instance, the materials and/or appearance of the decorative portion 6043 can be different from that of the body portion 6042 of the casing 604 or the frame 62 of the keyboard 6a; or, the key module 60 may additionally include a light-guiding element LG and a light emitting element (not shown), wherein the light-guiding element LG is disposed on the decorative portion 6043. In an embodiment, the light-guiding element LG can be optically connected between the decorative portion 6043 and the light emitting element, so that the light emitted by the light emitting element can illuminate the decorative portion 6043 through the light-guiding element LG. Thus, the user can freely change the decorative portion 6043, so that the block of the key module 60 can be different from other keys, and different key pressing experience or personal aesthetics can be provided.

Here, the key module 60 further may include a third coupling element C3 and a fourth coupling element C4. The third coupling element C3 can be disposed on the decorative portion 6043 of the casing 604, and the fourth coupling element C4, corresponding to the third coupling element C3, can be disposed on the body portion 6042 of the casing 604. The decorative portion 6043 can be disassembled from or assembled to the body portion 6042 through the third coupling element C3 and the fourth coupling element C4. In an embodiment, the third coupling element C3 and the fourth coupling element C4 respectively can be a magnetic element and a magnetic attraction component, so that the decorative portion 6043 can be disassembled from or assembled to the body portion 6042 by way of magnetic attraction. In some embodiment, the decorative portion is detachably assembled to the body portion through magnetic or mechanical engagement.

On the other hand, the way of replacing the key module 60 can be similar to the way of FIG. 7, and the difference lies in that the first coupling element C1 is disposed on the decorative portion 6043 of the casing 604 and the second coupling element C2 is also disposed on the frame 62. Thus, the key module 60 can be disassembled from or assembled to the replacement area of the frame 62 through the first coupling element C1 and the second coupling element C2, and different key pressing experience can be provided.

In an embodiment, the magnetic attraction between the third coupling element C3 and the fourth coupling element C4 can be greater than the magnetic attraction between the first coupling element C1 and the second coupling element C2, but this is not for limiting the invention.

Besides, the casing 604 can have a grip portion G disposed thereon. The grip portion G can be disposed on the decorative portion 6043 of the casing 604. The user, by flipping the grip portion G with his/her finger directly, can remove the key module 60 from the frame 62 or separate the decorative portion 6043 from the body portion 6042.

FIG. 16 to FIG. 18 are cross-sectional views exemplarily illustrating a number of examples of a keyboards 6b-6d according to another embodiment of the disclosure.

Refer to FIG. 16. The keyboard 6b is basically similar to the keyboard 6a of FIG. 15, and the difference lies in the positions of the first coupling element C1, the second coupling element C2, the third coupling element C3 and the fourth coupling element C4. The arrangement of the positions of the first coupling element C1 and the second coupling element C2 can be similar to that in the embodiment of FIG. 10. The decorative portion 6043 can be disassembled from or assembled to the body portion 6042 through the third coupling element C3 and the fourth coupling element C4. Besides, the key module 60 can be disassembled from or assembled to the replacement area of the frame 62 through the first coupling element C1 and the second coupling element C2.

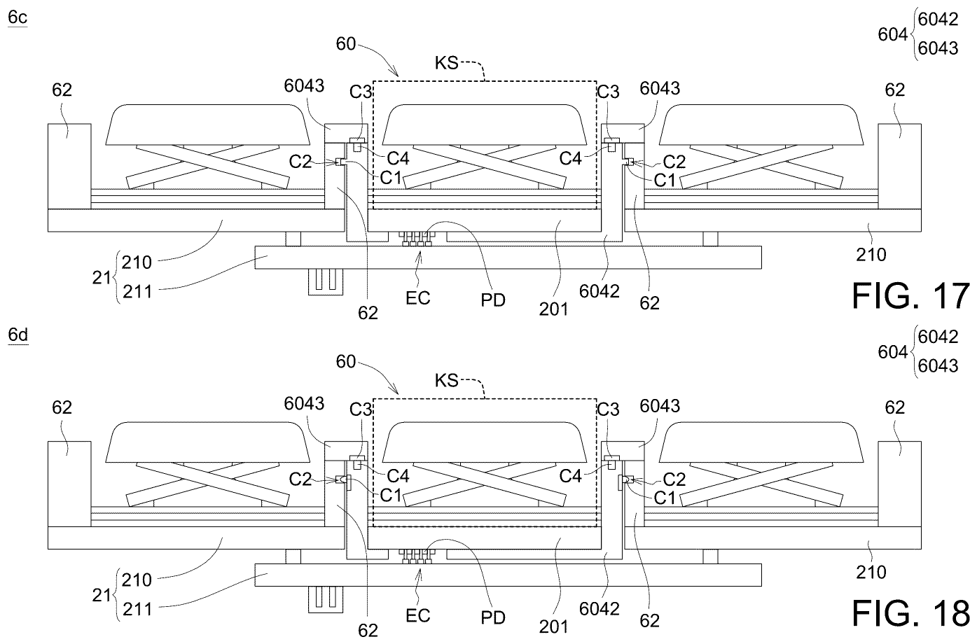

Refer to FIG. 17. The keyboard 6c is basically similar to the keyboard 6a of FIG. 15, and the difference lies in the types and positions of the first coupling element C1 and the second coupling element C2. In FIG. 17, the first coupling element C1 and the second coupling element C2 respectively can be a hook structure and a slot, and the key module 60 can be individually disassembled from or assembled to the frame 62 by de-buckling and buckling the hook structure and the slot.

Refer to FIG. 18. The keyboard 6d is basically similar to the keyboard 6c of FIG. 17, and the difference lies in the types of the first coupling element C1 and the second coupling element C2. In FIG. 18, the first coupling element C1 and the second coupling element C2 respectively can be a spring structure and a slot, the key module 60 can be individually disassembled from or assembled to the frame 62 by de-buckling and buckling the spring structure and the slot.

The arrangements of the types and positions of the first coupling element C1, the second coupling element C2, the third coupling element C3 and the fourth coupling element C4 are not limited to the arrangements exemplified in above embodiments. Other arrangements of types and positions of the third coupling element C3 and the fourth coupling element C4 which enable the decorative portion 6043 to be disassembled from or assembled to the body portion 6042, and Other arrangements of types and positions of the first coupling element C1 and the second coupling element C2 which enable the key module 60 to be disassembled from or assembled to the replacement area of the frame 62 are all within the scope of protection of the invention.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A keyboard, comprising:
a key module, comprising:
a keycap;
a modular circuit board, wherein the modular circuit board is rigid; and
a linkage element, located between the keycap and the rigid modular circuit board;
wherein the key module is detachably assembled to the keyboard.

2. The keyboard according to claim 1, further comprising a main circuit board, electrically connected to the modular circuit board.

3. The keyboard according to claim 2, wherein the keyboard comprises a plurality of key modules, the main circuit board has a plurality of accommodation areas, and one of the key modules is correspondingly disposed in one of the accommodation areas.

4. The keyboard according to claim 2, wherein an edge of the modular circuit board has a plurality of connection holes, and the connection holes of the modular circuit board are electrically coupled to the main circuit board.

5. The keyboard according to claim 2, wherein the linkage element comprises a connection structure and an elastic member disposed between the keycap and the modular circuit board; the key module further comprises a bottom plate, the connection structure is disposed between the keycap and the bottom plate, the modular circuit board is located above the bottom plate, and the bottom plate is engaged with the main circuit board.

6. The keyboard according to claim 2, wherein the modular circuit board comprises a pad, wherein the main circuit board comprises an electrical connector, and the modular circuit board and the main circuit board are electrically connected with each other through the pad and the electrical connector.

7. The keyboard according to claim 6, wherein the key module further comprises a casing, and the pad is exposed by the casing.

8. The keyboard according to claim 1, further comprising a frame having a replacement area, wherein the key module having a casing is located corresponding to the replacement area, the key module is capable of being disassembled from or assembled to the keyboard through a first coupling element of the key module and a second coupling element of the keyboard, the first coupling element is disposed on the casing, and the second coupling element is disposed on the frame.

9. The keyboard according to claim 8, wherein the casing comprises a decorative portion and a body portion, and the decorative portion is detachably assembled to the body portion through a third coupling element disposed on the decorative portion and a fourth coupling element disposed on the body portion.

10. A keyboard, comprising:
a key module, comprising:
a casing, having a plurality of key areas;
a plurality of keycaps, each being disposed in a corresponding key area;
a modular circuit board, disposed on the casing; and
a plurality of linkage elements, each being located between a corresponding keycap and the modular circuit board.

11. The keyboard according to claim 10, further comprising a frame having a replacement area corresponding to the key module, wherein the key module is connected to the frame.

12. The keyboard according to claim 11, wherein the key module is detachably assembled to the replacement area through a first coupling element disposed on the casing and a second coupling element disposed on the frame.

13. The keyboard according to claim 10, wherein the casing comprises a decorative portion and a body portion, and the decorative portion is detachably assembled to the body portion through a third coupling element disposed on the decorative portion and a fourth coupling element disposed on the body portion.

14. The keyboard according to claim 10, further comprising a main circuit board with an electrical connector, wherein the modular circuit board comprises a pad exposed by the casing, and the modular circuit board and the main circuit board are electrically connected to each other through the pad and the electrical connector.

15. The keyboard according to claim 10, wherein the key module further comprises a triggering circuit layer located between the keycaps and the modular circuit board.

16. The keyboard according to claim 15, wherein the key module further comprises a bottom plate located between the triggering circuit layer and the modular circuit board, and the linkage element comprises a connection structure disposed between a corresponding keycap and the bottom plate and an elastic member disposed between the corresponding keycap and the triggering circuit layer.

17. The keyboard according to claim 15, wherein the key module further comprises a conductive adhesive disposed between the triggering circuit layer and the modular circuit board.

18. The keyboard according to claim 10, wherein the linkage element comprises a shaft and a base disposed on the modular circuit board, and the shaft is located between a corresponding keycap and the base.

19. A keyboard, comprising:
a key module, comprising a casing; and
a frame, having a replacement area corresponding to the key module;
wherein the key module is disposed in the replacement area of the frame through the casing.

20. The keyboard according to claim 19, wherein the key module is detachably assembled to the frame through an engagement of a first coupling element disposed on the casing and a second coupling element disposed on the frame.

21. The keyboard according to claim 19, wherein the casing comprises a decorative portion and a body portion, and the decorative portion is detachably assembled to the body portion through magnetic or mechanical engagement.

22. The keyboard according to claim 21, wherein the key module further comprises a light-guiding element disposed on the decorative portion.

23. The keyboard according to claim 19, wherein the key module further comprises:
a keycap;
a modular circuit board, disposed on the casing; and
a linkage element, located between the keycap and the modular circuit board.

24. The keyboard according to claim 23, further comprising a main circuit board, wherein an edge of the modular circuit board has a plurality of connection holes electrically coupled to the main circuit board.

25. The keyboard according to claim 23, further comprising a main circuit board with a pad exposed by the casing, wherein the main circuit board comprises an electrical connector, and the modular circuit board and the main circuit board are electrically connected to each other through the pad and the electrical connector.

26. The keyboard according to claim 25, wherein the main circuit board comprises a first portion and a second portion differing in height from the first portion, and the electrical connector is disposed in the second portion.

27. The keyboard according to claim 23, wherein the key module further comprises a triggering circuit layer located between the keycap and the modular circuit board.

28. The keyboard according to claim 27, wherein the key module further comprises a bottom plate located between the triggering circuit layer and the modular circuit board, the linkage element comprises a connection structure and an elastic member, the elastic member is disposed between the keycap and the triggering circuit layer, and the connection structure is disposed between the keycap and the bottom plate.

29. The keyboard according to claim 27, wherein the key module further comprises a conductive adhesive disposed between the triggering circuit layer and the modular circuit board.

30. The keyboard according to claim 23, wherein the linkage element comprises a shaft and a base, the base is disposed on the modular circuit board, and the shaft is located between the keycap and the base.
